(19) United States
(12) Patent Application Publication
(10) Pub. No.: US 2004/0155028 A1
(43) Pub. Date: Aug. 12, 2004

(54) Heater pipe for radon mitigation

(76) Inventor: Michael Jeffery Doyle, Easton, PA (US)

Correspondence Address: Michael Doyle, 1235 Bushkill St, Easton, PA, 18042, US

(21) Appl. No.: 10/773,076

(22) Filed: Feb. 5, 2004

Related U.S. Application Data
(60) Provisional application No. 60/445,135, filed on Feb. 5, 2003.

(51) Int. Cl. H05B 3/02

(52) U.S. Cl. 219/535; 392/301

(57) ABSTRACT

A method and apparatus for radon mitigation using convection versus a fan to exhaust soiled radon contaminated air from beneath a building or dwellings foundation slab. Two suitable orifices one at each end of a dwellings foundations slab are created. On top of one orifice, a section of pipe with a heating element inside is placed. This is coupled with additional sections of pipe and routed vertically thru the dwellings roof. The heating element creates convection, which draws the air beneath the slab up exiting the dwelling at the roof. At the opposite end orifice a fresh air inlet pipe is placed drawing air from outside of dwelling. A suitable layer of gas permeable material is required under the slab for fresh air to flow. One major advantage of the heating element opposed to a fan is its indefinite life span.

### CROSS-REFERENCE TO RELATED APPLICATIONS

Provisional Patent Application, Application No. 60/445,135

Title: Heater Pipe for radon gas removal.

### FEDERAL SPONSORED RESEARCH

Not Applicable

### SEQUENCE LISTING OR PROGRAM

Not Applicable

### BACKGROUND OF THE INVENTION

1. Field of Invention

This invention relates to Radon Mitigation.

2. Background of the Invention

Radon comes from the natural (radioactive) breakdown of uranium in soil, rock and water and gets into the air you breathe. Radon can be found all over the U.S. It can get into any type of building—homes, offices, and schools—and result in a high indoor radon level.

Radon is a radioactive gas. It comes from natural decay of uranium that is found in nearly all soils. It typically moves up through the ground to the air above and into home through cracks and other holes in the foundation. The dwelling traps radon inside, where it can build up. Any home may have a radon problem. This means new, old homes, well sealed homes, drafty homes, and homes without basements.

Like other environmental pollutants, there is some uncertainty about the magnitude of radon health risks. However, we know more about radon risks than risks from most other cancer-causing substances. This is because estimates of radon risks are based on studies of cancer in humans (underground miners).

A method of radon mitigation in new home construction places a gas permeable layer beneath the foundations concrete slab. This layer is typically 4 to 6 inches of gravel. A polyethylene or equivalent flexible sheeting material is placed on top of the gas permeable layer. At one end of the slab a hole is cut in the flexible sheeting material. A section of 4 or 3-inch PVC pipe with a tee at one end is placed through the flexible sheeting into the gas permeable material. The tee is placed down and primarily used to support the PVC pipe that is then vertically routed straight up through the roof. An inline fan is installed in the PVC piping at the attic.

The fan draws the air up and creates a vacuum. Because typically this system does not have a fresh air input into the slabs gas permeable layer airflow is restricted. The system relies largely on vacuum to pull the radon out.

The method of using fans causes problems with noise and condensation building up on the inside of the pipe. The condensation then drips down on the fan creating noise. Because of the mechanical nature of the fan its life span is limited.

3. Objects and Advantages

Accordingly, several objects and advantages of my invention are:

(a) Elimination of noise.

(b) Higher temperatures evaporate moisture reducing or eliminating condensation building up on inside of pipe.

(c) Elimination of vacuum fan with moving parts increasing lifespan indefinitely.

(d) Elimination of a temperature control device.

(e) More effective means of removing gas from beneath foundations slab relying on flow versus vacuum.

Still further objects and advantages will become apparent from a consideration of the ensuing description and drawing.

### SUMMARY

In accordance with the present invention a heated convection duct is used for removal of Radon beneath a foundations slab.

### DRAWING—FIGURES

FIG. 1 Shows a perspective view of the Heater Pipe.

FIG. 2 Shows a cross sectional view of the interior components.

FIG. 3 Shows a bottom view.

FIG. 4 Shows a simplified cross sectional view of a basements concrete slab.

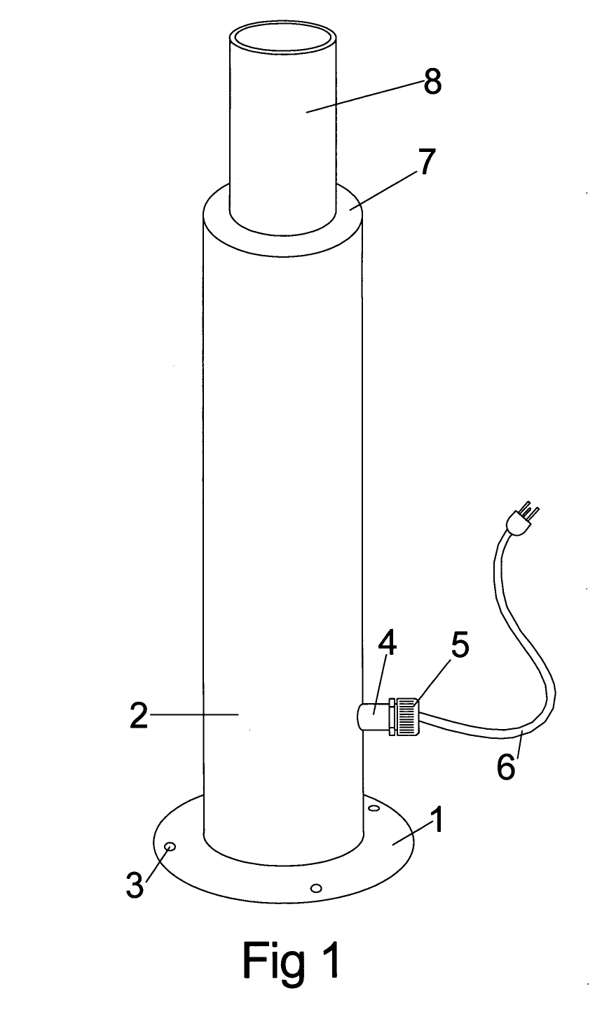

### DETAILED DESCRIPTION—FIG. 1,2,3,4

FIG. 1 is an exterior view of the heater pipes shell the described construction technique is done by welding several pieces together. Future production construction would more than likely be a one-piece metal casting.

Base 1 is typically 0.125-inch thick steel 9-inch diameter round plate with a centered 6-inch diameter hole. Base 1 also has four evenly spaced Mounting holes 3 are used to secure base to the dwelling foundation. Pipe 2 a section of 6-inch inner diameter approx 2-foot length and 0.125-inch wall thickness. Pipe coupling 4 is 0.500-inch. Pipe 2 has a hole cut approx 6 inches up from base the same diameter as Pipe coupling 4. Strain relief 5 is screwed into Pipe coupling 4 and has a rubber compression grommet to seal the High temperature 3-conductor electrical cord 6. The High temperature 3-conductor electrical cord 6 is then butt spliced with 900 deg high temp wire inside Pipe coupling 4 for added temperature protection connecting to Band Heater 13 and grounding. The other end is terminated with 110 vac electrical plug 15 amps. Reducer 7 is typically 0.125-inch thick steel plate 6-inch outer diameter with a centered 4-inch diameter hole. Exhaust 8 typically a section of 6-inch sch40 steel pipe 4-inch inner diameter. Exhaust 8 would typically be coupled with sch40 (PVC) Poly Vinyl Chloride pipe 4-inch inner diameter using a flexible rubber coupler. The PVC pipe is then routed outside the home or dwelling typically through the roof. Base 1, Pipe 2, Pipe coupling 4 Reducer 7 and Exhaust 8 are welded together as shown in FIG. 1.

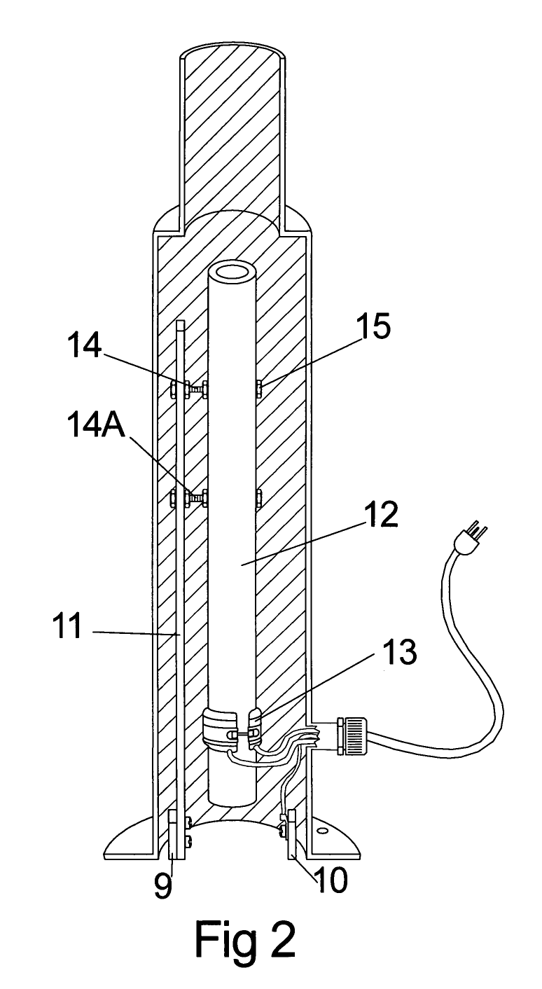

FIG. 2 is a cross sectional view of FIG. 1. Bracket 9 1.5×3×0.25 inch has two taped holes to support Bracket 11 1×16×0.25. Bracket 10 1.5×3×0.25 inch has one taped hole used for electrical grounding. Aluminum Pipe 12 2-inch inner diameter with 0.25-inch wall thickness 16-inch length. Band Heater 13 75 watt 110 VAC 1.5-inch width 2.5-inch inner diameter. 6-32 stainless steel threaded rod 14. 6-32 stainless steel threaded rod 14A. the threaded rods and nuts 15 support the Aluminum Pipe 12 in the center of Pipe 2 using Bracket 11 for support.

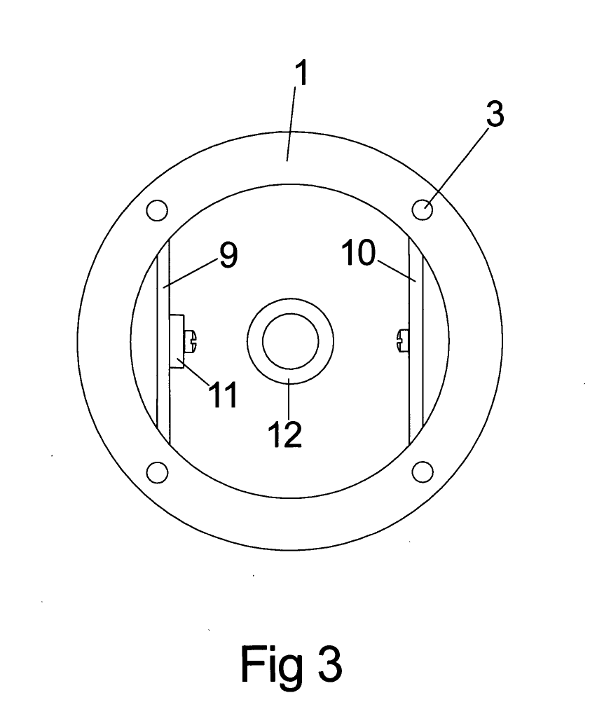

FIG. 3 is a bottom view showing placement of bracket 9 and bracket 10 that are welded on the inside of pipe 2.

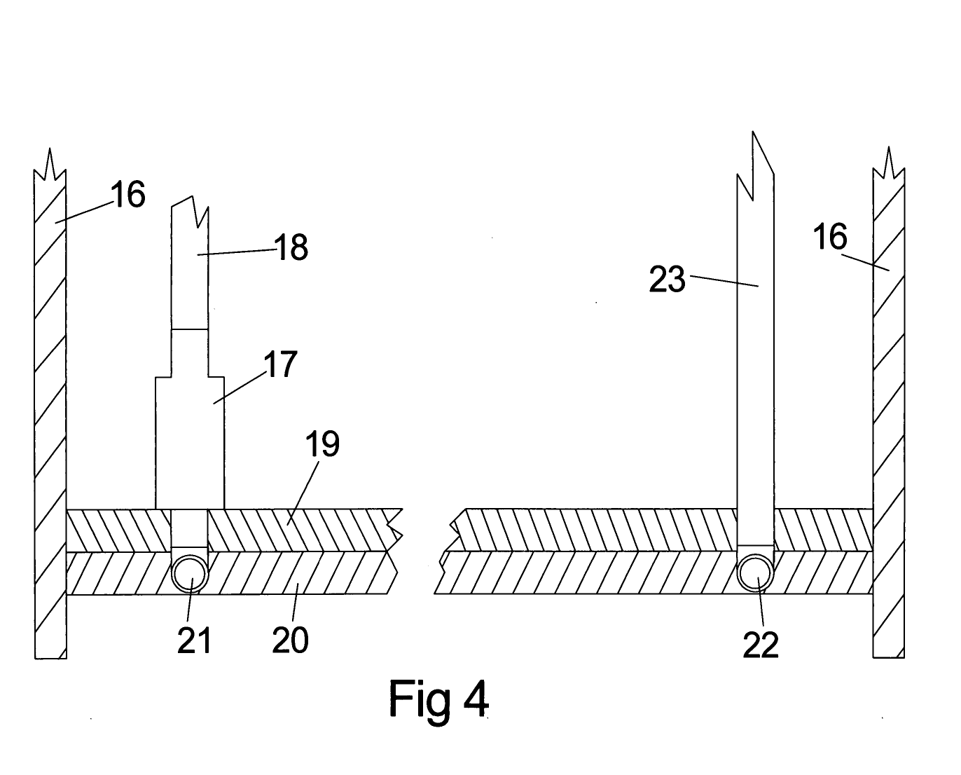

FIG. 4 is a simplified cross sectional view of a basements concrete slab. All PVC pipe and connection are typically 4-inch. Basement wall 16, Heater Pipe 17, PVC Exhaust Pipe 18, PVC Fresh Air Inlet Pipe 23, Foundations Concrete Slab 19, Gas Permeable Layer 20 is a layer of stone between 0.500-inch and 2-inch in diameter and 4 to 6 inches deep with a polyethylene or equivalent flexible sheeting material placed on top. The sheeting is laid across the entire layer of stone with a 12-inch overlap. PVC Tee 21 vertical section of tee has a short section of PVC pipe that is cut flush with the top of the Foundations concrete slab 19 The sheeting is cut to allow the PVC pipe to pass thru. PVC tee 22 vertical section of tee connects to the Air Inlet Pipe 23. The sheeting is cut to allow the PVC pipe to pass thru. The Air Inlet Pipe 23 would typically be routed straight up to a height approx 5 feet above ground level a 90 deg connection is use to direct PVC pipe outside of dwelling's wall.

The horizontal tee connections of both PVC tees 21 and PVC tee 22 would have perforated PVC pipe extending typically 5 feet in both directions. If tee is positioned in a corner then a 10 foot section of perforated PVC pipe is placed in one connection. This perforated section would increase airflow thru Gas Permeable Layer 20.

### OPERATION—FIG. 1,2,3,4

The Heater Pipe 17 uses heat generated from Band Heater 13 to heat Aluminum Pipe 12. The stabilizing temperature of the Aluminum Pipe 12 determines the wattage of Band Heater 13. By using a low wattage band heater a temperature control device can be eliminated. This reduces cost and eliminates cycling temperature that reduces life span of Band Heater 13. The use of a low wattage band heater also allows the Heater Pipe exterior temperature to remain low enough that PVC piping can be used for the exhaust pipe 18

The heat generated inside the heater pipe creates a convection flow of air. The exhaust pipe 18 creates a stack effect increasing the airflow. The height of the stack and the diameter is a critical component in the airflow the higher the stack the faster the airflow. Testing on a free standing heater pipe using a 4 inch diameter stack with a ten foot section of PVC for the stack produced approx 100 fpm. With 75 watt band heater 13.

Testing has also shown that the heater pipe does create vacuum and is not comparable to a radon fan designed for vacuum. Because of this limitation, special attention needs to be applied to the slabs construction.

Fresh air flows into Gas Permeable Layer 20 under slab from Air Inlet Pipe 23. The Heater Pipe 17 using convection creates a airflow that removes soiled air from beneath slab. The soiled air is then exited from the dwelling by Exhaust Pipe 18.

Although the description above contains many specifics, these should not be construed as limiting the scope of the invention but merely as providing illustrations of some of the present preferred embodiments of this invention. For example the heater pipe would work without a fresh air inlet and without the slab preparation on some building with natural air flow under slab. In addition, the band heaters 13 wattage can vary a higher watt heater will create more flow. Typically, you would start with the lowest watt band heater around 75.

Thus the scope of the invention should be determined by the appended claims and there legal equivalent, rather than by examples given.

I claim my invention as follows:

1. An apparatus for withdrawal of ground originating air together with any radon content from under a building comprising:
(a) a heated convection duct extending from orifice in ground or basement slab to the exterior of building.
(b) a source of heat within the duct to engender a convection current of air from the orifice to the exterior.

2. An apparatus in accordance with claim 1 wherein the heat source is comprised of heater elements within the heated convection duct.

3. An apparatus in accordance with claim 2 wherein the heating elements are electrical heating elements.

4. A method of removing radon containing residual air from under a ground or basement slab in a building comprising
(a) providing a opening through said slab and
(b) drawing air from under said slab by establishing a convection flow of air through heated convection duct leading from said opening in said slab by means of a heated convection duct connected to said opening and extending to an exhaust vent.
